(19) United States
(12) Patent Application Publication
(10) Pub. No.: US 2026/0276608 A1
(43) Pub. Date: Sep. 17, 2026

(54) METHOD FOR HIGH THROUGHPUT IDENTIFICATION OF TRACE ORGANIC CONTAMINANTS IN BLOOD BASED ON MICROSAMPLES

(71) Applicant: NANJING UNIVERSITY, NANJING (CN)

(72) Inventors: SI WEI, NANJING (CN); LAIHUI LI, NANJING (CN); NANYANG YU, NANJING (CN); XUEBING WANG, NANJING (CN); HONGXIA YU, NANJING (CN)

(73) Assignee: NANJING UNIVERSITY, NANJING (CN)

(21) Appl. No.: 18/726,814

(22) PCT Filed: Feb. 24, 2022
(86) PCT No.: PCT/CN2022/077588

§ 371 Date: Mar. 16, 2026

(30) Foreign Application Priority Data
Jan. 6, 2022 (CN) 202210011503.3

(51) Int. Cl. G01N 30/88; G01N 30/06; G01N 30/86

(52) U.S. Cl. CPC G01N 30/88; G01N 30/06; G01N 30/86; G01N 2030/8822

(57) ABSTRACT

The disclosure provides a method for high-throughput identification of trace organic contaminants in blood based on microsamples, which belongs to the field of biochemistry and analytical chemistry. The method includes: step 1: sample preprocessing: extracting contaminants; step 2: instrumental determination: full-scan analyzing and detecting the preprocessed samples by UPLC-Q-Exactive liquid-mass spectrometry; step 3: sample peaks extraction; step 4: contaminant identification: based on the sample peaks extracted in the step 3, targeting and identifying the organic contaminants by library matching, and/or identifying the organic contaminants not capable of being targeted and identified with molecular network tools. The method of the disclosure requires only a micro-volume (30-100 μL) of blood sample, achieves lower sample volume requirements, higher throughput identification, and higher sensitivity identification to identify organic contaminants in vivo. The disclosure provides a scientific basis for research on the relationship between environmental exposure and human health.

### CROSS-REFERENCE TO RELATED APPLICATIONS

This application is a national stage application of International Patent Application No. PCT/CN2022077588, filed on Feb. 24, 2022, which claims priority of Chinese Patent Application No. 202210011503.3, filed on Jan. 6, 2022, and which are incorporated by reference herein in their entirety as part of the present application.

### TECHNICAL FIELD

The disclosure belongs to the field of biochemistry and analytical chemistry, and specifically relates to a method for high-throughput identification of trace organic contaminants in blood based on microsamples.

### BACKGROUND

With the development of industry, organic contaminants in the environment, such as organic pesticides, pharmaceutical personal care products (PPCPs) and endocrine disrupting contaminants (EDCs), are becoming more and more prevalent. When the human body is exposed to the environment, organic contaminants in the environment can enter the human body through various routes, such as skin contact, inhalation or diet, and transform from external to internal exposure, and then enrich or metabolize in the body, inducing diseases such as inflammation, chronic diseases (e.g., diabetes, etc.), and cancers, which pose a serious threat to human health. Blood (including serum, plasma and whole blood) is the main biospecimen for contamination of the human body, so identification of organic contaminants in blood is extremely important.

Identification of organic contaminants in blood includes both target and nontarget analytical methods, with the former being used for high concentrations of chemicals and the latter for low concentrations. Rappaport et al. found that a wide range of environmental contaminants are present in the human body at concentrations thousands of times lower than those of food and pharmaceutical compounds or metabolites, and are often below the detection limits of non-targeted methods under laboratory conditions (S. M. Rappaport, et al. “The Blood Exposome and Its Role in Discovering Causes of Disease” Environ. Health Perspect. 122(8), 769-774 (2014)). As a result, larger volumes of biological samples are required for extraction and analysis, such as the National Health and Nutrition Examination Study (NHANES) related method that requires 10 mL of sample for the determination of difficult-to-degrade organics in serum. The GC-MS/MS method developed by Agilent for the analysis of difficult-to-degrade organic contaminants in human plasma limits the sample volume to 200 μL.

However, the commonly used method of blood collection, venous blood collection, is invasive. Samples from populations that are more difficult to sample (e.g., infants, the elderly, etc.) are highly prized, and as a result, it is often impossible to collect a sufficient volume of sample for analysis. Insufficient sample volume prevents nontarget analyses and also fails to cover the large number of organic contaminants at low concentrations in the sample, resulting in low identification throughput.

Therefore, it is important to develop a screening method for organic pollutants with microsamples and high throughput identification of compounds.

### SUMMARY

### 1. Problem to be Solved

The disclosure provides a method for high-throughput identification of trace organic contaminants in blood based on micro-volume samples in response to the problem that the identification of trace organic contaminants in blood requires large-volume samples. The disclosure can achieve high-throughput and high-sensitivity identification of organic pollutants in the human body with only a micro volume (30-100 μL) of blood samples, which can provide a scientific basis for the study of the relationship between environmental exposure and human health.

### 2. Technical Solution

In order to solve the above problems, the technical solutions adopted in the disclosure are as follows.

The disclosure provides a method for high throughput identification of trace organic contaminants in blood based on microsamples, the method includes the following steps.

Step 1: sample preprocessing: adding 30 to 100 μL of a blood samples to a 96-well plate, and adding extractant according to a ratio between a volume of the blood sample and a mass of the extractant being 1:(0.54±0.2); adding a fixed volume of 300-400 μL of acetonitrile to obtain a mixture, and centrifuging a supernatant after vortex mixing the mixture; concentrating the supernatant by nitrogen blowing and re-solubilising through 100 μL of acetonitrile to obtain a preprocessed sample.

Preferably, the extractant is magnesium sulfate-sodium chloride mixture.

Preferably, the fixed volume of acetonitrile is 300-400 μL for removing lipids and proteins from the blood sample. Further, the volume is 300 μL. As disclosed in Chinese Patent Application No. CN109187840A, a high-throughput screening and analysis method for organic contaminants in blood, in which the organic extraction solvent is three times the volume of blood. However, in practice, due to the viscous and other characteristics of blood, the volume of blood cannot be measured accurately, resulting in a certain error; in addition, since the volume of solvent needs to be added according to the sample volume, it may be impossible to add the extraction solvent at the same time in a large batch, which results in a low efficiency of the detection of the blood samples. The added amount of acetonitrile in the disclosure is a fixed volume, which is independent of the volume of the blood sample, and can be added at the same time in large quantities, which improves the efficiency of the assay.

Preferably, adding steel balls to solution prior to the vortex mixing. Further, the number of steel balls is 2.

Preferably, the centrifugation conditions are 3000-4000 r, 10-20 min. Further, the centrifugation conditions are 3500 r, 15 min. Preferably, the sample preprocessing further includes process blank samples, and a process of the sample preprocessing is repeated with an equal volume of Fisher water instead of the blood sample.

Preferably, the 96-well plate is a WebSeal™ 96 square-well microplate (Thermo Scientific) with a well volume of 1000 μL, which is compatible with all 96-well configurations of autosamplers.

Preferably, the nitrogen blowing is performed using a 96-well nitrogen blower with gentle blow-drying at room temperature for sample concentration.

Preferably, a 12-channel row gun is used for liquid transfer during the sample preprocessing, and the use of the row gun reduces human error and improves efficiency.

Step 2: instrumental determination: performing a full-scan analytical detection on the preprocessed samples by a UPLC-Q-Exactive liquid-mass spectrometry instrument.

Preferably, conditions of the UPLC-Q-Exactive liquid mass spectrometry instrument are:
chromatograph: Ultimate 3000 ultra-high performance liquid chromatography (Thermo fisher, USA);
chromatograph column: C18 column (2.1 mm×50 mm, 2.5 μm);
column temperature: 40° C.;
flow rate: 0.3 mL/min;
positive ion mode mobile phase: 0.1% formic acid-water solution (phase A), methanol (phase B);
negative ion mode mobile phase: 2 mM ammonium acetate-aqueous solution (phase A), methanol (phase B).

Gradient elution table:

| Time (min) | A % | B % |
|---|---|---|
| 1.00 | 90 | 10 |
| 1.00 | 90 | 10 |
| 36.00 | 0 | 100 |
| 50.00 | 0 | 100 |
| 50.00 | 90 | 10 |
| 55.00 | 90 | 10 |

mass spectrometer: Q-Exactive electrostatic field orbitrap high resolution mass spectrometer;
full scan mode: data dependent scanning mode;
ion source: positive and negative electrospray ionisation source;
full-scan mass range: MS1 80-1000 Da, MS2 50-800 Da;
collision energy: ±35 eV;
collision energy spread: 15 eV;
ion source temperature: 412.5° C.

Step 3: sample peaks extraction: extracting the sample peaks in the organic contaminants' spectrum obtained from the instrumental analysis in step 2 with MSDIAL ver 4.48 software.

Preferably, saving results of a spectra of the organic contaminants obtained from the instrumental analysis in the step 2 as a RAW file, converting to an ABF file through a format converter, and then importing into the MSDIAL ver 4.48 software to extract sample peaks.

Preferably, parameters of the sample peaks extraction are set as:
peak extraction mass range: 80-1000 Da;
peak extraction mass error: 0.01 Da;
signal-to-noise ratio of peak extraction: S:N>3;
retention time of peak extraction: 1-50 min.

Preferably, the sample peaks extraction further includes an alignment correction, parameters of the alignment correction are set as:
alignment retention time error: 0.1 min;
alignment mass error: 0.015 Da.

Preferably, the sample peak extraction further includes filtering, process blank samples is used to reduce false positive results, and the parameters of the sample peak filtering are set as:
based on 3σ principle, a sample peak area greater than a blank sample peak area average+3std is retained.

Step 4: contaminant identification: based on the sample peaks extracted in step 3, targeting and identifying the organic contaminants by library matching, and/or identifying the organic contaminants not capable of being targeted and identified with molecular network tools. Molecular networks are interconnected networks of molecules that compare collected data with data from the MS2 spectral library and connect to similar spectra based on cosine similarity. The molecular network visualises and annotates the sample data to further enhance the identification throughput.

Preferably, the targeting and identifying the organic contaminants by library matching includes loading a MSP database file for positive and negative ion modes in the MSDIAL software, respectively, and comparing and matching with a list of the sample peaks, where the matching labels include exact mass number, retention time, isotopic distribution, and MS2 spectral information.

Preferably, matching parameters set in MSDIAL software are:
mass error: 0.002 Da for MS1 and 0.01 Da for MS2;
retention time tolerance error: 2 min; and
scoring value threshold: 80.

Preferably, identification using molecular network tools includes clustering and annotating the mass spectral fragments (peak lifting results) of a sample based on cosine similarity based on the Global Natural Product Social Molecular Networking (GNPS). GNPS is a fundamental tool for data processing through peak detection and peak alignment, taking into account the isotopic peaks, MS2 information and retention times of the molecules, and is suitable for high-throughput screening of compounds in blood samples to further improve identification throughput.

Preferably, parameters for constructing the molecular network based on the GNPS platform are set as:
Min Paris Cos: 0.7;
Network Topk: 10;
Maximum Connected Component Size: 100;
Minimum Matched Fragment Ions: 2;
Minimum Cluster Size: 1;
GNPS database used includes MONA, BERKELEY-LAB, BILELIB19, CASMI, SCIEX, NIH-CLINICALCOLLECTION1, NIH-CLINICALCOLLECTION2, SELLECKCHEM-FDA-PART1, SELLECKCHEM-FDA-PART2, NIH-NATURALPRODUCTSLIBRARY, NIST14-MATCHES, IOBA-NHC, PNNL-LIPIDS, IQAMDB, LDB_POSITIVE, LDB_POSITIVE, MMV_POSITIVE, NIH-SMALLMOLECULEPHARMACOLOGICALLYACTIVE.

Search parameter for the GNPS Library are set as:
Library Search Min Matched: 2;
Score Threshold: 0.7;
Maximum Analog Search Mass Difference: 100.

### 3. Beneficial Effect

The beneficial effects of the disclosure compared to the prior art are as follows.

First, a method for high throughput identification of trace organic contaminants in blood based on microsamples according to the disclosure requires only 30-100 μL of blood samples, which substantially reduces the volume of samples used. At the same time, the combination of nontarget screening technology ensures the detection of organic compounds in the sample, the screening of organic contaminants with high throughput for microsamples is realized, and the effect that a microsample can reflect the exposure group of organic contaminants in the human body is achieved.

Second, in the method for high throughput identification of trace organic contaminants in blood based on microsamples according to the disclosure, the volume of the organic solvent added to extract the contaminant in the sample preprocessing is a fixed value, independent of the volume of the blood sample. In other words, there is no need to add a fixed multiple volume of organic solvent according to the volume of the blood sample, which is beneficial for large batches of blood samples and improves work efficiency.

Third, the method for high-throughput identification of trace organic contaminants in blood based on microsamples according to the disclosure can effectively extract polar organic compounds in blood in sample preprocessing, exclude the influence of protein interference, and subsequently screen for organic pollutants with high coverage in combination with liquid-quality analysis.

### BRIEF DESCRIPTION OF THE DRAWINGS

FIG. 1 shows a flowchart of a method for high throughput identification of trace organic contaminants in blood based on microsamples according to the disclosure;

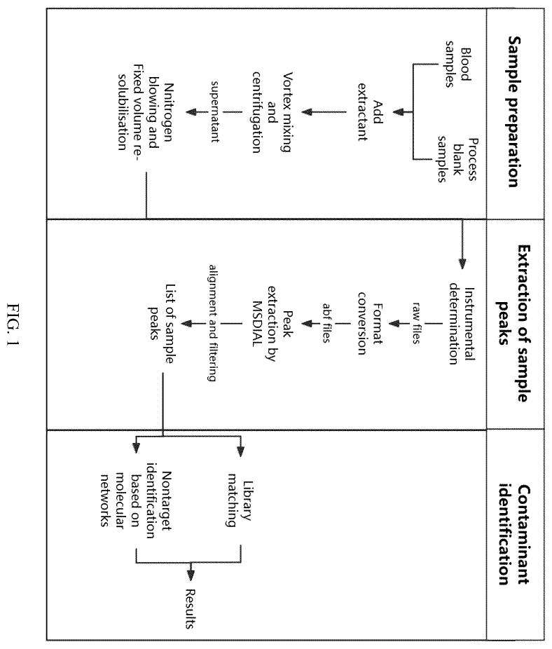

FIG. 2A1 shows 35 μl chromatographic outflow diagram of 30 μL whole blood sample injection;

FIG. 2A2 shows 35 μL chromatographic outflow diagram of 30 μL whole blood sample injection (repeat experiment);

FIG. 2A3 shows 85 μL chromatographic outflow diagram of 30 μL whole blood sample injection;

FIG. 2B1 shows 35 μL chromatographic outflow diagram of 50 μL whole blood sample injection;

FIG. 2B2 shows 35 μL chromatographic outflow diagram of 50 μL whole blood sample injection (repeat experiment);

FIG. 2B3 shows 85 μL chromatogram outflow diagram of 50 μL whole blood sample;

FIG. 2C1 shows 85 μL chromatogram outflow diagram of 100 μL whole blood sample;

FIG. 2C2 shows 85 μL chromatogram outflow diagram of 100 μL whole blood sample (repeat experiment);

FIG. 2C3 shows 85 μL chromatogram outflow diagram of 100 μL whole blood sample (repeat experiment);

FIG. 2D1 shows a table of the number of the samples peaks obtained from extraction and identification;

FIG. 2D2 shows a diagram of the number of the samples peaks obtained from extraction and identification; and

FIG. 3 shows the results of identification based on the GNPS molecular network tool.

### DETAILED DESCRIPTION OF THE EMBODIMENTS

The disclosure is further described below in connection with specific embodiments.

It should be noted that, unless otherwise defined, all technical and scientific terms used herein have the same meaning as commonly understood by those skilled in the art of the disclosure; the term “and/or” as used herein includes any and all combinations of one or more of the relevant listed items.

The specific conditions in the embodiments without indication are carried out according to conventional conditions or conditions recommended by the manufacturer. Reagents or instruments used without indication of the manufacturer are conventional products that can be obtained through commercially available purchases.

Concentration, volume and other numerical data are presented herein in a range format. It should be understood that such a range format is used for convenience and brevity only, and should be flexibly interpreted to include not only the values explicitly recited as the limits of the range, but also all of the individual values or sub-ranges encompassing the stated range, as if each value and sub-ranges were explicitly recited. For example, the range of values from about 1 to about 4.5 should be interpreted to include not only the explicitly stated limit values from 1 to about 4.5, but also the separate numbers (such as 2, 3, 4) and sub-ranges (such as 1 to 3, 2 to 4, etc.). The same principle applies to ranges that describe only one value, such as “less than about 4.5”, which should be interpreted as including all of the above values and ranges. In addition, this interpretation should apply regardless of the breadth of the range or characteristic being described.

Any of the steps described in any method or process claim may be performed in any order and are not limited to the order presented in the claim.

### Embodiment 1

This embodiment provides a validation of a method for high throughput identification of trace organic contaminants in blood based on microsamples. Specifically, four standards are added to a blood sample and identified in the steps as follows.

Step 1: sample preparation:
1 mL of blood sample is taken and add a variable volume of four standard substances, namely nicotinamide, isoleucine, phenylalanine and 1-tryptophan are added, a concentration is not higher than 20 ppb.

Step 2: standard identification:

First, 30, 50 and 100 μL of blood samples are added into 96-well plates, the mixture according to a ratio between blood sample and magnesium sulfate-sodium chloride mixture as 1:(0.54±0.2) is added, 300 μL of acetonitrile solvent and 2 steel beads are added quickly and then vortex is performed immediately after mixing. The mixed samples are centrifuged (3500 r, 15 min) and the supernatant obtained after centrifugation is transferred; the supernatant is nitrogen-blown to near-dryness and then re-dissolving is performed with the use of 100 μL of acetonitrile; three replicates are prepared for each sample, and the process blanks are repeated with an equal volume of Fisher's water instead of blood samples.

Second, the preprocessed samples are analysed and detected by full-scan analysis with a UPLC-Q-Exactive liquid-mass spectrometry system (Thermo fisher, USA). Its instrumental setup parameters are:
chromatograph: Ultimate 3000 ultra performance liquid chromatography;
chromatograph column: C18 column (2.1 mm×50 mm, 2.5 μm);
column temperature: 40° C.;
flow rate: 0.3 mL/min;
mobile phase: 0.1% formic acid-water solution (positive ion mode phase A) and methanol (phase B);

gradient elution:

| Time (min) | A % | B % |
|---|---|---|
| 1.00 | 90 | 10 |
| 1.00 | 90 | 10 |
| 36.00 | 0 | 100 |
| 50.00 | 0 | 100 |
| 50.00 | 90 | 10 |
| 55.00 | 90 | 10 |

mass spectrometer: Q-Exactive electrostatic field orbitrap high resolution mass spectrometer;
full scan mode: data dependent acquisition mode;
ion source: positive and negative electrospray ionisation source;
full-scan mass range: MS1 80-1000 Da, MS2 50-800 Da;
collision energy: ±35 eV;
collision energy spread: 15 eV;
ion source temperature: 412.5° C.

Step 3: the RAW file obtained from the instrumental analysis is opened to obtain the chromatographic outflow profile of the sample, and the RAW file is converted to an ABF file using a format converter and imported into MSDIAL ver 4.48 software to extract the sample peaks.

All samples are corrected for peak alignment and process blanks are used to reduce false positive results. The parameters for peak extraction, alignment and filtering are set as:

peak extraction mass range: 80-1000 Da;
peak extraction mass error: 0.01 Da;
signal-to-noise ratio of peak extraction: S:N>3;
retention time of peak extraction: 1-50 min;
alignment retention time error: 0.1 min;
alignment mass error: 0.015 Da.

The sample peak area greater than the blank sample peak area average+3std is retained.

Step 4: the MSP database file (including MassBank and other databases) of the positive ion mode is loaded in MSDIAL software to compare and match with the sample peak list. The matching labels include the exact mass number, retention time, isotopic distribution and secondary spectral information, and the matching parameters set in MSDIAL are:
mass error: 0.002 Da for MS1 and 0.01 Da for MS2;
retention time tolerance error: 2 min;
scoring value threshold: 80.

The results are shown in Table 1, where the retention times and MS2 spectra of the standards are successfully matched in each sample, and four of the standards are detected in all samples.

TABLE 1
Detection results of the standards in these embodiments

| | Molecular | | 30- | 30- | 30- | 50- | 50- | 50- | 100- | 100- | 100- |
|---|---|---|---|---|---|---|---|---|---|---|---|
| Standards | formula | m/z | 35-1 | 35-2 | 85-3 | 35-1 | 35-2 | 85-3 | 85-1 | 85-2 | 85-3 |
| Nicotinamide | C₆H₆N₂O | 123.0553 | 1.74 | 1.44 | 1.54 | 1.44 | 1.42 | 1.68 | 1.88 | 1.55 | 1.58 |
| Isoleucine | C₆H₁₃NO₂ | 132.1030 | 1.43 | 1.44 | 1.74 | 1.44 | 1.43 | 1.54 | 1.43 | 1.55 | 1.62 |
| Phenylalanine | C₉H₁₁NO₂ | 166.0861 | 1.43 | 1.44 | 1.53 | 1.44 | 1.43 | 1.54 | 1.57 | 1.55 | 1.62 |
| L-Tryptophan | C₁₁H₁₂N₂O₂ | 205.0972 | 5.00 | 5.02 | 5.18 | 5.01 | 5.04 | 5.15 | 5.15 | 5.11 | 5.21 |

### Embodiment 2

The embodiment provides a method for high-throughput identification of trace organic contaminants in blood based on micro samples, specifically a library-matched suspect identification method for organic contaminants in children's whole blood, which includes the following steps.

Step 1: 30, 50 and 100 μL of children's whole blood samples are added to a 96-well plate, the mixture according to the ratio between blood sample and magnesium sulphate-sodium chloride mixture as 1:(0.54±0.2) is added, 300 μL of acetonitrile solvent and 2 steel beads are quickly added and then vortex and mixing well are performed immediately; the mixed samples are centrifuged (3,500 r, 15 min) and the supernatant is transferred; re-dissolution is performed with the 100 μL of acetonitrile after the supernatant by nitrogen blowing to nearly dry; each sample is prepare three replicates of the sample, the process of the blank samples are prepared with an equal volume of Fisher water instead of the blood samples to repeat the above process.

Step 2: full-scan analytical detection of preprocessed samples is performed by the UPLC-Q-Exactive liquid-mass spectrometry instrument. The parameters of the UPLC-Q-Exactive liquid-mass spectrometry instrument are set as follows:
chromatograph: Ultimate 3000 ultra-high performance liquid chromatography (Thermo fisher, USA);
chromatograph column: C18 column (2.1 mm×50 mm, 2.5 μm);
column temperature: 40° C.;
flow rate: 0.3 mL/min;
positive ion mode mobile phase: 0.1% formic acid-water solution (positive ion mode phase A), methanol (phase B);
negative ion mode mobile phase: 2 mM ammonium acetate-aqueous solution (phase A), methanol (phase B);

gradient elution table:

| Time (min) | A % | B % |
|---|---|---|
| 1.00 | 90 | 10 |
| 1.00 | 90 | 10 |
| 36.00 | 0 | 100 |
| 50.00 | 0 | 100 |
| 50.00 | 90 | 10 |
| 55.00 | 90 | 10 |

mass spectrometer: Q-Exactive electrostatic field orbitrap high resolution mass spectrometer;
full scan mode: data dependent scanning mode;
ion source: positive and negative electrospray ionisation source;
full-scan mass range: MS1 80-1000 Da, MS2 50-800 Da;
collision energy: ±35 eV;
collision energy spread: 15 eV;
ion source temperature: 412.5° C.

Step 3: the RAW file obtained from the instrumental analysis is opened to obtain the chromatographic outflow profile of the sample, and the RAW file is converted to an ABF file using a format converter and imported into MSDIAL ver 4.48 software to extract the sample peaks.

All samples are corrected for peak alignment and process blanks are used to reduce false positive results. The parameters for peak extraction, alignment and filtering are set as:
peak extraction mass range: 80-1000 Da;
peak extraction mass error: 0.01 Da;
signal-to-noise ratio of peak extraction: S:N>3;
retention time of peak extraction: 1-50 min.
alignment retention time error: 0.1 min;
alignment mass error: 0.015 Da;
retain the peak area of the sample which is larger than the peak area of the blank sample average+3std.

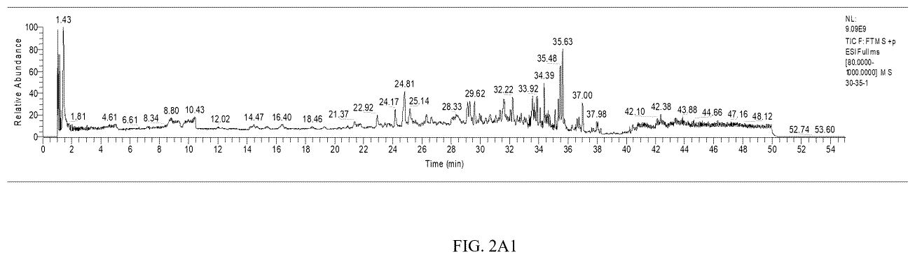

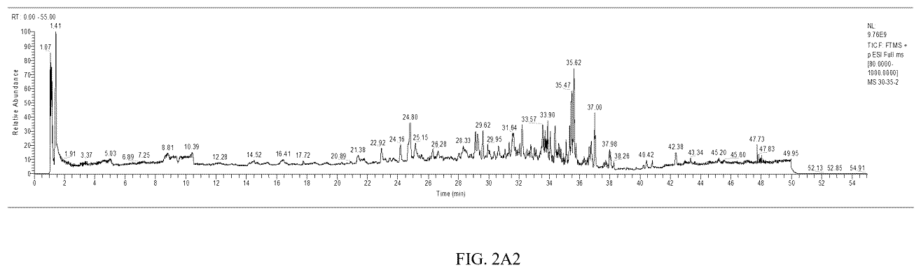

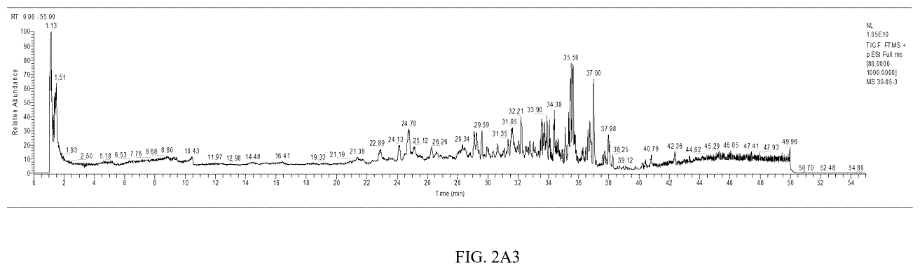

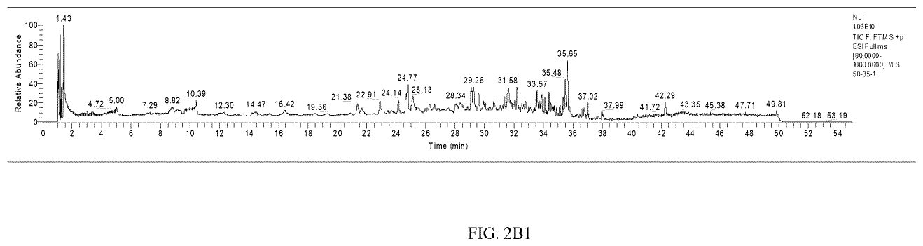

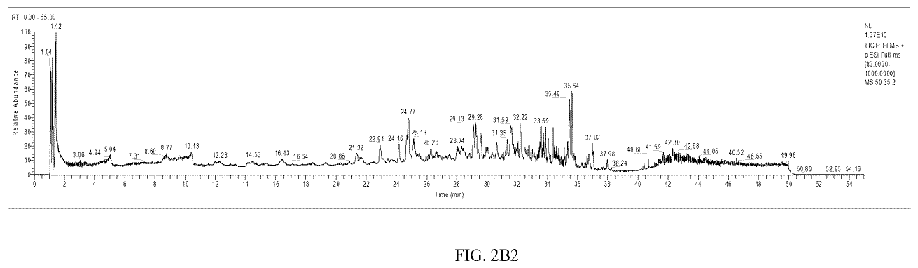

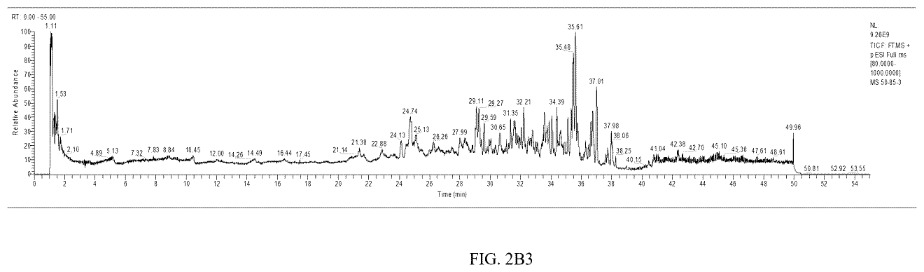

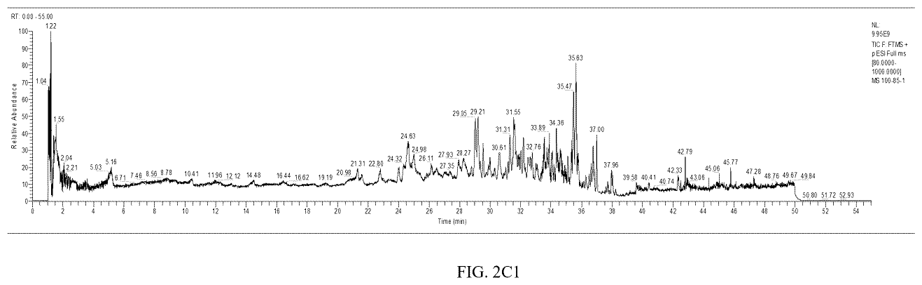

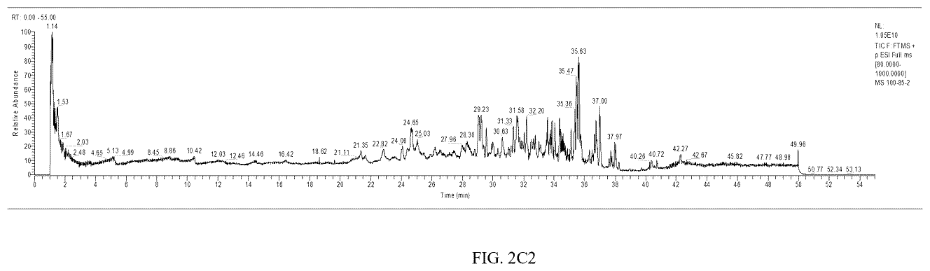

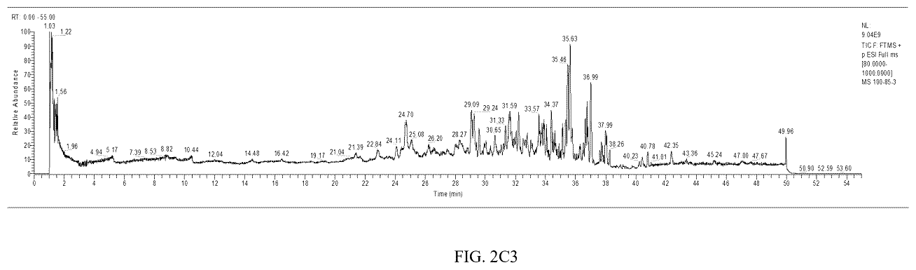

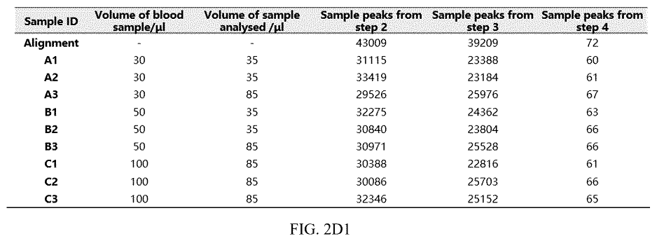

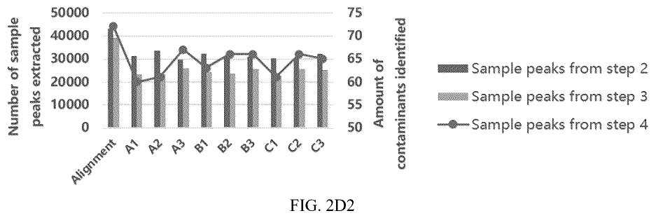

As can be seen in FIGS. 2A1-2D2, the chromatographic outflow profiles in the three experiments are similar, the detected peaks are stable, the differences in the number of identified contaminants are small, and the method are reproducible. The difference in the number of contaminants identified by the large volume injections (as shown in FIG. 2C1, FIG. 2C2, FIG. 2C3) in the 100 μL blood sample experiment and the large volume injections (as shown in FIG. 2A3, FIG. 2B3) in the 30 μL and 50 μL blood sample experiments is small, which proves that the method of the disclosure can achieve the same screening effect of the micro-volume samples. The small difference in the number of contaminants identified by the small-volume feeds (as shown in FIG. 2A1, FIG. 2A2, FIG. 2B1, FIG. 2B2) versus the large-volume feeds (as shown in FIG. 2A3, FIG. 2B3) for the 30 μL and 50 μL blood sample experiments demonstrates that equivalent screening results can be achieved with small-volume feeds using method of the disclosure, which reduces the volume of samples used for reproducible assays.

Step 4: the MSP database file (including MassBank and other databases) of the positive ion mode is loaded in MSDIAL software to compare and match with the sample peak list. The matching labels include the exact mass number, retention time, isotopic distribution and MS2 spectral information, and the matching parameters set in MSDIAL are:
mass error: 0.002 Da for MS1 and 0.01 Da for MS2;
retention time tolerance error: 2 min;
scoring value threshold: 80 points.

The organic contaminants identified in this embodiment are shown in Table 2, totaling 68 species.

TABLE 2
Organic contaminants identified in this embodiment

| No | Name | CAS number | RT | m/z |
|---|---|---|---|---|
| 1 | (1R,4R,6R,10S)-4,12,12-trimethyl-9-methylene-5- | 1139-30-6 | 9.20 | 243.17 |
| | oxatricyclo[8.2.0.0~4,6~]dodecane | | | |
| 2 | (R)-(−)-Phenylephrine | 59-42-7 | 12.33 | 168.10 |
| 3 | 1-(pyrimidin-2-yl)pyrrolidine-2-carboxylic acid | 1009282-26-1 | 1.11 | 216.07 |
| 4 | 10b-Hydroxy-3-isobutyl-6,10b,11,11a-tetrahydro-2H- | — | 15.55 | 316.17 |
| | pyrazino[1′,2′:1,5]pyrrolo[2,3-b]indole-1,4(3H,5aH)- | | | |
| | dione | | | |
| 5 | 2-(4-oxoquinazolin-3(4H)-yl)ethyl isobutyrate | — | 6.21 | 261.13 |
| 6 | 2,6-Xylidine | 87-62-7 | 2.44 | 122.10 |
| 7 | 2-[(2′R,8R,8aS)-2′,4,4,7,8a-pentamethylspiro[2,3,4a,5- | 1438-57-9 | 32.80 | 343.23 |
| | tetrahydro-1H-naphthalene-8,5′-oxolane]-2′-yl]acetic acid | | | |
| 8 | 2-Isopropylthioxanthone | 5495-84-1 | 31.73 | 255.08 |
| 9 | 2-Phenylacetamide | 103-81-1 | 7.77 | 136.08 |
| 10 | 2-Piperidone | 675-20-7 | 1.44 | 100.08 |
| 11 | 3-Indoleacetic acid | 87-51-4 | 13.07 | 176.07 |
| 12 | 3-Indolepropionic acid | 830-96-6 | 16.44 | 190.09 |
| 13 | 4-acetyloxy-8-(3-oxo-2-pent-2-enylcyclopenten-1- | — | 24.06 | 373.20 |
| | yl)octanoic acid | | | |
| 14 | 4′-ethenyl-2′-hydroxy-1,4′,4a-trimethyl-5- | — | 26.77 | 357.20 |
| | oxospiro[2,3,4,7,8,8a-hexahydronaphthalene-6,1′- | | | |
| | cyclopentane]-1-carboxylic acid | | | |
| 15 | 4-hydroxy-4-(pyridin-2-yl)butan-2-one | 6337-41-3 | 2.84 | 188.07 |
| 16 | 4-Hydroxybenzaldehyde | 123-08-0 | 7.69 | 123.04 |
| 17 | 8-{(1S,5R)-4-Oxo-5-[(2Z)-2-penten-1-yl]-2-cyclopenten- | 67204-66-4 | 25.37 | 275.20 |
| | 1-yl}octanoic acid | | | |
| 18 | Acitretin | 55079-83-9 | 9.26 | 327.20 |
| 19 | Arachidonic Acid | 506-32-1 | 35.65 | 305.25 |
| 20 | Benzoic acid | 65-85-0 | 7.79 | 123.04 |
| 21 | Carveol | 99-48-9 | 28.49 | 135.12 |
| 22 | Chenodeoxycholic acid | 474-25-9 | 29.65 | 357.28 |
| 23 | Cholest-4,6-Dien-3-One | 566-93-8 | 40.80 | 383.33 |
| 24 | Choline | 62-49-7 | 33.42 | 104.11 |
| 25 | Cortisol | 50-23-7 | 20.14 | 363.22 |
| 26 | Dehydrosalsolidine | 4721-98-6 | 1.57 | 206.12 |
| 27 | Dibutyl phthalate | 84-74-2 | 2.98 | 279.16 |
| 28 | Dodemorph | 1593-77-7 | 32.50 | 282.28 |
| 29 | Ethyl-4-dimethylaminobenzoate | 10287-53-3 | 24.42 | 194.12 |
| 30 | Glycochenodeoxycholic acid | 640-79-9 | 30.15 | 450.32 |
| 31 | Hypoxanthine | 68-94-0 | 1.71 | 137.05 |
| 32 | Indole-3-acetaldehyde | 2591-98-2 | 13.33 | 160.08 |
| 33 | Indole-3-carbinol | 700-06-1 | 13.36 | 130.06 |
| 34 | Indole-3-carboxyaldehyde | 487-89-8 | 12.13 | 146.06 |
| 35 | Indole-3-carboxylic acid | 771-50-6 | 12.50 | 162.06 |
| 36 | Indoline | 496-15-1 | 3.70 | 120.08 |
| 37 | Isoleucine | 2095501-92-9 | 2.05 | 132.10 |
| 38 | Lathyrol | 34420-19-4 | 29.05 | 357.20 |
| 39 | Lauroylcarnitine | 25518-54-1 | 28.44 | 344.28 |
| 40 | Leucylalanine | 67368-02-9 | 1.43 | 203.14 |
| 41 | Leucylleucine | 6403-35-6 | 1.69 | 245.19 |
| 42 | Leucylproline | 6403-35-6 | 3.91 | 229.16 |
| 43 | Linolenic acid | 463-40-1 | 36.51 | 301.21 |
| 44 | L-Pipecolic acid | 3105-95-1 | 3.60 | 130.09 |
| 45 | L-Tryptophan | 73-22-3 | 5.17 | 205.10 |
| 46 | Methionine | 59-51-8 | 1.43 | 150.06 |
| 47 | Monoolein | 111-03-5 | 32.91 | 357.30 |
| 48 | Morpholine | 110-91-8 | 1.59 | 88.08 |
| 49 | N,N-Dimethylaniline | 121-69-7 | 1.91 | 122.10 |
| 50 | N,N-Dimethyldodecylamine N-oxide | 1643-20-5 | 27.80 | 230.25 |
| 51 | Nicotinamide | 98-92-0 | 1.88 | 123.06 |
| 52 | N-Methylaniline | 100-61-8 | 1.54 | 108.08 |
| 53 | Norambreinolide | 564-20-5 | 7.33 | 273.18 |
| 54 | Palmitoylcarnitine | 1935-18-8 | 34.00 | 400.34 |
| 55 | Phenylalanine | 150-30-1 | 1.64 | 166.09 |
| 56 | Phenylalanylisoleucine (isomer of 1329) | 3303-55-7 | 1.54 | 279.17 |
| 57 | Phosphocholine | 3616-04-4 | 34.20 | 184.07 |
| 58 | Phthalic anhydride | 85-44-9 | 29.60 | 149.02 |
| 59 | Piperazine-2,5-dione | 106-57-0 | 1.19 | 137.03 |
| 60 | Piperine | 94-62-2 | 25.62 | 286.14 |
| 61 | Sophocarpine | 6483-15-4 | 29.84 | 247.18 |
| 62 | Spathulenol | 6750-60-3 | 6.21 | 243.17 |
| 63 | Threonylleucine (isomer of 809, 926) | 50299-12-2 | 4.18 | 233.15 |
| 64 | Triphenylphosphine oxide | 791-28-6 | 23.57 | 279.09 |
| 65 | Tryptophan | 54-12-6 | 1.55 | 205.10 |
| 66 | Uracil | 66-22-8 | 1.40 | 113.03 |
| 67 | Urocanic acid | 104-98-3 | 1.35 | 139.05 |
| 68 | Valine | 516-06-3 | 1.43 | 118.09 |

Step 5: molecular network-based nontarget identification analysis is performed on three sets of mass spectrometry data, in FIG. 2A3, FIG. 21B3 and FIG. 2C3, with parameter settings:
parameter settings for the construction of molecular networks based on the GNPS platform:
Min Pari s Cos: 0.7;
Network Topk: 10;
Maximum Connected Component Size: 100;
Minimum Matched Fragment Ions: 2;
Minimum Cluster Size: 1;
the GNPS database used includes MONA, BERKELEY-LAB, BILELIB19, CASMI, SCIEX, NIH-CLINICALCOLLECTION1, NII-CLINICALCOLLECTION2, SELLECKCHEM-FDA-PART1, SELLECKCHEM-FDA-PART2, NIH-NATURALPRODUCTSLIBRARY, NIST14-MATCHES, IOBA-NHC, PNNL-LIPIDS, IQAMDB, LDB_POSITIVE, LDB_POSITIVE, MMV_POSITIVE, NIH-SMALLMOLECULEPHARMACOLOGICALLYACTIVE.

Library search parameter settings:
Library Search Min Matched: 2;
Score Threshold: 0.7;
Maximum Analog Search Mass Difference: 100.

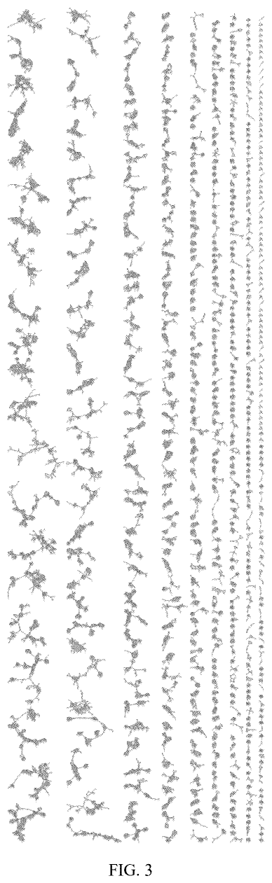

Preferably, the identification using the molecular network tool includes:
the results of the recognition based on the GNPS molecular network tool are shown in FIG. 3. The dots in FIG. 3 indicate identified compounds, and the edges indicate two-by-two correlations between compounds, e.g., “parent” and “product” formed by fragmentation pattern similarity, and each cluster represents a similarity network. The identified substances are shown in Table 3, a total of 123 newly identified chemicals are added, and the similarity relationships between these chemicals are shown in FIG. 3.

TABLE 3
Organic contaminants identified based on the GNPS molecular network tool

| Name | Name |
|---|---|
| 2-amino-3-methylpentanoic acid | Butylidenephthalide |
| 2-Isopropylthioxanthone | Carboxymethyl-[3-(dodecanoylamino)propyl]-dimethylazanium |
| 2-methoxycarbonylbenzoic acid | Carveol |
| 2-phenylacetamide | Cholesta-4,6-dien-3-one |
| 2-propan-2-ylthioxanthen-9-one | Cholesta-5,7-dien-3beta-ol |
| 3-(2-methylpropyl)-3a,4,5,6-tetrahydro-2-benzofuran-1(3h)-one | Cholestan-3-one, (5.alpha.)- |
| 3-(Dodecanoylamino)propyl(carboxymethyl)dimethylammonium | Cholesterol |
| 3-(Octyloxy)propan-1-amine | Choline |
| 3,5,5-trimethylcyclohex-2-en-1-one | Cis-5,8,11,14-Eicosatetraenoic acid |
| 3,6,9,12-Tetraoxatetracosan-1-ol | Cis-7,10,13,16,19-Docosapentaenoic acid |
| 3.beta.-Hydroxy-5-cholenoic acid | Cis-9-Hexadecenoic acid |
| 3-octadecanoyloxy-4-(trimethylazaniumyl)butanoate | Cobadex |
| 3-octoxypropan-1-amine | Conjugated linoleic Acid (10E,12Z) |
| 4-Cholesten-3-one | Conjugated linoleic acid (9E.11E) |
| 4-hydroxybenzaldehyde | Cuminyl alcohol |
| 4-Hydroxynonenal | Cyclopentasiloxane, decamethyl- |
| 4-Phenyl-3-buten-2-one | DBP |
| 5-HETE | Decynediol, tetramethyl, di(2-hydroxyethyl) ether |
| 5-HETE lactone | Deoxybenzoin |
| 5-Hydroxy-6E.8Z,11Z.14Z,17Z-eicosapentaenoic acid | Deoxycholate |
| 6-Aminocaproic acid | D-erythro-C18-Sphingosine |
| 6-Methylcoumarin | Desmosterol |
| 7-ketocholesterol | Di(2-ethylhexyl)phthalate (DEHP) |
| 7-Oxocholesterol | Dibutyl phthalate |
| 8,9-Dihydroxy-5Z,11Z,14Z-eicosatrienoic acid | DIBUTYL SEBACATE |
| 8-{(1S,5R)-4-Oxo-5-[(2Z)-2-penten-1-yl]-2-cyclopenten-1-yl}octanoic acid | Didodecyl 3,3′-thiodipropionate oxide |
| 8-HETE | Diethyl phthalate |
| 8-hydroxy-8-(3-octyloxiran-2-yl)octanoic acid | Dihydro-3-methylmethcathinone |
| 8S-Hydroxy-5Z,9E.11Z,14Z-eicosatetraenoic acid | Diisopropyl phthalate |
| Tyrosine | Tryptophan |
| Val-Leu | Val-Ile |

| Name | Name |
|---|---|
| Ile-Leu | Palmitoleic acid |
| Indole-3-carboxaldehyde | Palmitoyl carnitine |
| Indole-3-carboxylic acid | Palmitoyl ethanolamide |
| Indoleacetic acid | Pentaethylene glycol |
| Indolepropionic acid | Perillaldehyde |
| Isoleucine | Petroselinic acid |
| Isophorone | Phe-Leu |
| Isotretinoin | PHENYLALANINE |
| Lauramidopropyl betaine | Phe-Phe |
| Lauric acid leelamide | Phe-Pro |
| Lauryldiethanolamine | Phe-Val |
| Leu-Trp | Phthalic anhydride |
| Leu-Val | Piperine |
| Linoleic acid | Prostaglandin A1 |
| Linolenic acid | Prostaglandin E2 |
| Linoleoyl ethanolamide | Pterosin A |
| LPC 18:2 | Pterosin B |
| L-Tryptophan | Pyridine-3-carboxamide |
| L-Tyrosine | PyroGlu-Val |
| LysoPAF | Rac-glycerol 1-myristate |
| Lyso-PAFC-18 | Ser-Phe |
| Lyso-PC(16:0) | Sphinganine |
| Methenamine | Stearic acid |
| Methionine | Stearidonic acid |
| Methyl trans-styryl ketone | Stearoylcarnitine |
| Monoelaidin | Stearoyl-L-Carnitine |
| Monolaurin | Tetradecyldiethanolamine |
| Monomethyl phthalate | Tetraethylene glycol monododecyl ether |
| Monomyristin | Trans-EKODE-(E)-lb |
| Zymosterol | Tributyl 2-acetyloxypropane-1.2.3-tricarboxylate |
| Valine | |

1. A method for high-throughput identification of trace organic contaminants in blood based on microsamples, wherein the method comprises:
step 1: sample preprocessing: adding 30 to 100 μL of a blood sample to a 96-well plate, and adding extractant according to a ratio between a volume of the blood sample and a mass of the extractant being 1:(0.54±0.2); adding a fixed volume of 300-400 UL acetonitrile to obtain a mixture, and centrifuging a supernatant after vortex mixing the mixture; concentrating the supernatant by nitrogen blowing and re-solubilising through 100 μL of acetonitrile to obtain a preprocessed sample;
step 2: instrumental determination: performing a full-scan analytical detection on the preprocessed sample by a UPLC-Q-Exactive liquid-mass spectrometry instrument; wherein parameters of the UPLC-Q-Exactive liquid-mass spectrometry instrument are:
chromatograph: Ultimate 3000 ultra-high performance liquid chromatography (Thermo fisher, USA);
chromatograph column: C18 column (2.1 mm×50 mm, 2.5 μm);
column temperature: 40° C.;
flow rate: 0.3 mL/min;
positive ion mode mobile phase: 0.1% formic acid-water solution (phase A), methanol (phase B):
negative ion mode mobile phase: 2 mM ammonium acetate-aqueous solution (phase A), methanol (phase B);
gradient elution table:

| Time (min) | A % | B % |
|---|---|---|
| 1.00 | 90 | 10 |
| 1.00 | 90 | 10 |
| 36.00 | 0 | 100 |
| 50.00 | 0 | 100 |
| 50.00 | 90 | 10 |
| 55.00 | 90 | 10 |

mass spectrometer: Q-Exactive electrostatic field orbitrap high resolution mass spectrometer;
full scan mode: data dependent scanning mode;
ion source: positive and negative electrospray ionisation source;
full-scan mass range: MS1 80-1000 Da, MS2 50-800 Da;
collision energy: ±35 eV;
collision energy spread: 15 eV:
ion source temperature: 412.5° C.;
step 3: sample peaks extraction: saving results of a spectra of organic contaminants obtained from instrumental analysis in the step 2 as RAW files, converting to ABF files through a format converter and then importing into MSDIAL ver 4.48 software to extract sample peaks;
step 4: contaminant identification: based on the sample peaks extracted in the step 3, targeting and identifying the organic contaminants by library matching, and/or identifying the organic contaminants not capable of being targeted and identified with molecular network tools.

2. The method for high throughput identification of trace organic contaminants in blood based on microsamples according to claim 1, wherein the extractant is a magnesium sulphate-sodium chloride mixture.

3. (canceled)

4. (canceled)

5. (canceled)

6. The method for high throughput identification of trace organic contaminants in blood based on microsamples according to claim 4, wherein parameters for the sample peaks extraction in the step 3 are set as:
peak extraction mass range: 80-1000 Da;
peak extraction mass error: 0.01 Da;
signal-to-noise ratio of peak extraction: S:N>3;
retention time of peak extraction: 1-50 min.

7. The method for high throughput identification of trace organic contaminants in blood based on microsamples according to claim 6, wherein the sample peaks extraction in the step 3 further comprises an alignment correction, and parameters for the alignment correction of the sample peaks are set as:
alignment retention time error: 0.1 min;
alignment mass error: 0.015 Da.

8. The method for high throughput identification of trace organic contaminants in blood based on microsamples according to claim 7, wherein the sample peaks extraction in the step 3 further comprises filtering, parameters for sample peaks filtering are set as:
based on 3σ principle, retaining a sample peak area greater than a blank sample peak area average+3std.

9. The method for high throughput identification of trace organic contaminants in blood based on microsamples according to claim 8, wherein the targeting and identifying the organic contaminants by library matching in the step 4 comprises loading a MSP library file of positive and negative ion modes in MSDIAL software, respectively; and comparing and matching with a list of the sample peaks, wherein matching labels comprise exact mass number, retention time, isotopic distribution, and MS2 spectra information; and/or identifying by the molecular network tools comprises clustering and annotating mass spectral fragments of the blood sample according to a similarity based on GNPS.

10. The method for high throughput identification of trace organic contaminants in blood based on microsamples according to claim 9, wherein parameters set in the MSDIAL software are:
mass error: 0.002 Da for MS1 and 0.01 Da for MS2;
retention time tolerance error: 2 min;
scoring value threshold: 80;
parameters of matching feature ions are set as:
mass error: 0.005 Da;
retention time tolerance error: 0.1 min;
and/or parameters for constructing molecular networks based on GNPS platform are set as:
Min Paris Cos: 0.7;
Network Topk: 10;
Maximum Connected Component Size: 100;
Minimum Matched Fragment Ions: 2;
Minimum Cluster Size: 1;
GNPS library used comprises MONA, BERKELEY-LAB, BILELIB19, CASMI, SCIEX, NIH-CLINICALCOLLECTION1, NIH-CLINICALCOLLECTION2, SELLECKCHEM-FDA-PART1, SELLECKCHEM-FDA-PART2, NIH-NATURALPRODUCTSLIBRARY, NIST14-MATCHES, IOBA-NHC, PNNL-LIPIDS, IQAMDB, LDB_POSITIVE, LDB_POSITIVE, MMV_POSITIVE, NIH-SMALLMOLECULEPHARMACOLOGICALLYACTIVE;
search parameters for the GNPS library are set as:
Library Search Min Matched: 2;
Score Threshold: 0.7;
Maximum Analog Search Mass Difference: 100.
